(19) United States
(12) Patent Application Publication
(10) Pub. No.: US 2020/0071235 A1
(43) Pub. Date: Mar. 5, 2020

(54) CURING AGENT FOR CURING A POLYMER RESIN

(71) Applicant: Arkema France, Colombes (FR)

(72) Inventor: Bin JI, Jiangsu (CN)

(21) Appl. No.: 16/466,065

(22) PCT Filed: Dec. 8, 2017
(86) PCT No.: PCT/EP2017/082045

§ 371 Date: Jun. 3, 2019

(30) Foreign Application Priority Data
Dec. 8, 2016 (FR) 1662155

(51) Int. Cl. C04B 40/00; C04B 24/00; C04B 24/04; C04B 26/18; C04B 14/06

(52) U.S. Cl. CPC C04B 40/0039; C04B 24/008; C04B 2111/542; C04B 26/18; C04B 14/06; C04B 24/045

(57) ABSTRACT

A curing agent comprising methyl isobutyl ketone peroxide and at least one peroxide.

### FIELD OF THE INVENTION

The invention relates to a curing agent for curing a polymer resin, in particular a polymer ester resin, preferably chosen in the group consisting of an unsaturated polyester resin, an acrylic resin, methacrylic resin and a vinyl ester resin, and a composition comprising this curing agent. The invention also relates to the use of a curing agent for the preparation of a synthetic stone.

### BACKGROUND OF THE INVENTION

Thermoset resins are commonly used to manufacture composites, coatings, and can more generally be used as binder for different types of powders and fibers. In particular, synthetic stones simulating various natural stones such as marble, quartz or granite are commonly used in the industry. By way of example, synthetic stones are used for the manufacture of various shaped articles such as floor, internal or external walls, tiles, countertops, sinks, table tops or architectural facings.

Synthetic stones are typically made from a composition comprising polymer resins, mineral fillers, curing agents and other compounds such as pigments, coupling agents, and colorants.

Polymer resins provide for good mechanical and chemical properties, weather resistance and low cost. Furthermore, polymer resins are easy to handle and can be pigmented, which is advantageous for the preparation of synthetic stone shaped articles.

The conversion of the polymer resin from a liquid to a solid results from the cross-linking reaction between the polymer resin and a reactive monomer to form a three-dimensional network. A notable example of reactive monomer used in this frame is styrene. (Meth)acrylic monomers are also sometimes used, especially methyl methacrylate.

Curing agents are generally needed to induce the cross-linking reaction of the polymer resin with the reactive monomer. Curing agents frequently used in the art notably encompass organic peroxides.

However, such curing agents have a curing behaviour which may affect the curing rate and/or the final quality of the resin. High curing rates are favourable for a manufacturing standpoint but may be detrimental as the cure reaction is exothermic and too high temperatures may generate stress and cracks in the final material. This can be particularly detrimental in the preparation of synthetic stones.

By way of example, organic peroxides, such as tert-butylperoxy 2-ethylhexanoate disclosed in European application EP1878712, give rise to an elevated peak temperature, i.e. the temperature of transition from liquid to solid, leading to a high curing rate.

Accordingly, there is a need for alternative curing agents, yielding a lower peak temperature and allowing for lower curing rate, thus avoiding cracks and degradation in synthetic stones.

### SUMMARY OF THE INVENTION

The present invention results from the unexpected finding, by the inventors, that a curing agent, comprising a methyl isobutyl ketone peroxide and at least one organic peroxide of formula (I) could cure a polymer resin, preferably selected in the group consisting of an unsaturated polyester resin, acrylic resin, methacrylic resin and vinyl ester resin, at lower peak temperatures and lower curing rates than provided by curing agents of the art.

The inventors also found that the curing agent according to the invention could be stored at higher temperature than curing agents of the art, in particular at room temperature. This is advantageous as the sensitivity to heat of organic peroxides can cause transport and storage issues due to their self-decomposition.

The inventors have further found that the curing agent according to the invention allowed the formation of synthetic stones involving styrene cross-linking with a lower residual styrene content than with curing agents of the art. This is advantageous as residual styrene released from synthetic stones may be the cause of environmental pollution, may have undesirable effects, such as bad smell, and may be the source of harmful voids and blister on the surface of synthetic stones at elevated temperature. Nowadays, to decrease the residual monomers, the curing temperature is increased, leading to a higher reaction peak and thus in the cracking or degradation of the synthetic stones.

Accordingly, the present invention relates to a curing agent comprising at least one ketone peroxide and at least one organic peroxide of the following formula (I):

R₁—O—O—R₂ (I)

wherein
R₁ represents an alkyl group having from 1 to 30 carbon atoms, an alkylen group having from 2 to 30 carbon atoms, an aryl group having from 3 to 30 carbon atoms or a cycloalkyl group having from 3 to 30 carbon atoms, wherein the alkyl, alkylen, aryl or cycloalkyl group is optionally substituted by an alkyl group having from 1 to 30 carbon atoms, an alkylen group having from 2 to 30 carbon atoms, an aryl group having from 3 to 30 carbon atoms or a cycloalkyl group having from 3 to 30 carbon atoms; and
R₂ represents a —C(═O)R₃, group, a —C(═O)OR₃ group, a —R₃OOR₄ group, an alkyl group having from 1 to 30 carbon atoms, an alkylen group having from 2 to 30 carbon atoms, an aryl group having from 3 to 30 carbon atoms or a cycloalkyl group having from 3 to 30 carbon atoms, preferably R₂ represents a —C(═O)R₃, group, a —C(═O)OR₃ group, an alkylen group having from 2 to 30 carbon atoms, an aryl group having from 3 to 30 carbon atoms or a cycloalkyl group having from 3 to 30 carbon atoms, and even more preferably R₂ represents a —C(═O)R₃ or a —C(═O)OR₃ group, wherein
   the alkyl, alkylen, aryl or cycloalkyl group is optionally substituted by an alkyl group having from 1 to 30 carbon atoms, an alkylen group having from 2 to 30 carbon atoms, an aryl group having from 3 to 30 carbon atoms and a cycloalkyl group having from 3 to 30 carbon atoms, and
   R₃ and R₄ each independently represents an alkyl group having from 1 to 30 carbon atoms, an alkylen group having from 2 to 30 carbon atoms, an aryl group having from 3 to 30 carbon atoms and a cycloalkyl group having from 3 to 30 carbon atoms, wherein the alkyl, alkylen, aryl or cycloalkyl group is optionally substituted by an alkyl group having from 1 to 30 carbon atoms, an alkylen group having from 2 to 30 carbon atoms, an aryl group having from 3 to 30 carbon atoms and a cycloalkyl group having from 3 to 30 carbon atoms.

The invention also relates to a composition comprising:
at least one polymer resin, in particular at least one polymer ester resin, preferably chosen in the group consisting of unsaturated polyester resin, acrylic resin, methacrylic resin and vinyl ester resin, more preferably chosen in the group consisting of unsaturated polyester resin and vinyl ester resin,
at least one mineral filler, and
at least one curing agent as defined above.

Preferably, the composition as defined above further comprises at least one additional agent selected from the group consisting of a coupling agent, a colorant, a pigment, an accelerator, an inhibitor, a diluent, a dispersing agent and an UV stabilizer.

Preferably, the composition as defined above is exempt of a metal catalyst, in particular the composition as defined above is exempt of a metal catalyst chosen in the group consisting of a cobalt catalyst and a zinc catalyst.

Preferably, the above-defined composition is exempt of ammonium salt.

The invention also relates to the use of a curing agent as defined above, for curing a polymer resin, in particular a polymer ester resin, preferably chosen in the group consisting of unsaturated polyester resin, acrylic resin, methacrylic resin or a vinyl ester resin, more preferably chosen in the group consisting of unsaturated polyester resin and vinyl ester resin.

Preferably, the invention relates to the use of a curing agent as defined above for the preparation of a synthetic stone.

The invention also relates to a method for the preparation of a synthetic stone comprising a step of subjecting the composition as defined above to a temperature allowing curing.

Said method can also encompass a previous step of preparing the composition as defined above.

Said method can also encompass a previous step of forming the composition as defined above into a desired shape.

Preferably, the method for the preparation of a synthetic stone according to the invention comprises the steps of:
optionally, preparing a composition as defined above,
optionally, forming the composition into a desired shape, and
subjecting the composition to a temperature allowing curing.

The invention also relates to a synthetic stone obtainable by the method as defined above.

### DETAILED DESCRIPTION OF THE INVENTION

As intended herein, the term “comprising” has the meaning of “including” or “containing”, which means that when an object “comprises” one or several elements, other elements than those mentioned may also be included in the object. In contrast, when an object is said to “consist of” one or several elements, the object is limited to the listed elements and cannot include other elements than those mentioned.

Curing Agent

As intended herein, the term “alkyl” refers to linear, branched or cyclic alkyl groups, “aryl” refers to aromatic groups comprising at least one aromatic ring, and “alkylaryl” refers to aryl groups substituted by at least one alkyl group.

Preferably, the organic peroxide of formula (I) according to the invention is selected from the group consisting of peroxyesters, peroxyketals, and monoperoxycarbonates, and more preferably the organic peroxide of formula (I) is selected from the group consisting of peroxyesters, peroxyketals, and monoperoxycarbonates and even more preferably the organic peroxide of formula (I) according to the invention is a peroxyester.

Preferably, the organic peroxide of formula (I) has a one hour half life temperature ranging from 100° C. and 140° C., preferably ranging from 110° C. and 130° C.

Preferably also, the organic peroxide of formula (I) according to the invention is represented by the following formula (II):

R₅—O—O—R₆ (II)

wherein:
R₅ represents an alkyl group having from 1 to 6 carbon atoms, and
R₆ represents a —C(═O)R₇, a —C(═O)OR₇ group or a —R₇OOR₈ group, wherein R₇ and R₈ each independently represents an alkyl group having from 1 to 10 carbon atoms, a cycloalkyl group having from 3 to 6 carbon atoms or an aryl group having from 3 to 6 carbon atoms, preferably R₆ represents a —C(═O)R₇ or a —C(═O)OR₇ group.

More preferably, the organic peroxide of formula (I) or (II) according to the invention is represented by at least one of the following formulae (III), (IV), (V), (VI) and (VII), preferably is represented by at least one of the following formulae (III), (IV), and (V):

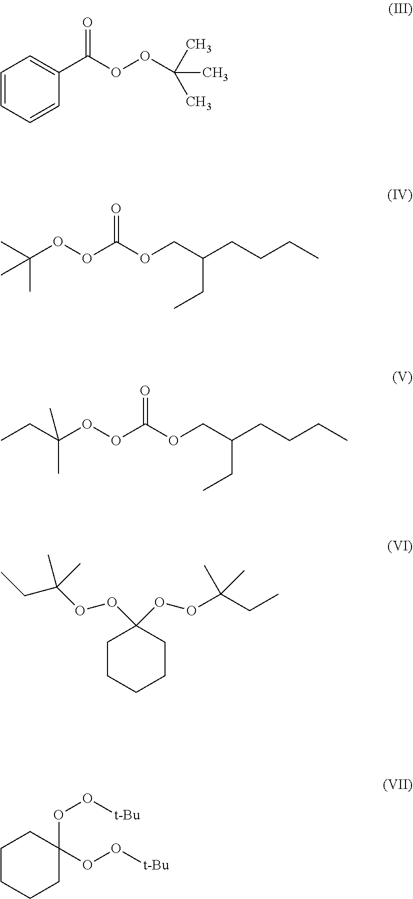

or a combination thereof.

The compound of formula (III) is tert-butyl peroxybenzoate, the compound of formula (IV) is OO-tert-butyl-O-(2-ethylhexyl)-monoperoxycarbonate, the compound of formula (V) is OO-tert-amyl-O(2-ethylhexyl)-monoperoxycarbonate, the compound of formula (VI) is 1,1-bis(tert-amylperoxy)cyclohexane and the compound of formula (VII) is 1,1-bis(tert-butylperoxy)cyclohexane.

By way of example, the organic peroxide according to the invention can be found in Luperox® products (Arkema), in particular, tert-butyl peroxybenzoate can be found in Luperox® P; OO-tert-butyl-O-(2-ethylhexyl)-monoperoxycarbonate can be found in Luperox® TBEC; OO-tert-amyl-O(2ethylhexyl)-monoperoxycarbonate can be found in Luperox® TAEC; 1,1-bis(tert-amylperoxy)cyclohexane can be found in Luperox® 531M80 and 1,1-bis(tert-butylperoxy)cyclohexane can be found in Luperox®331M80, preferably is selected in the group consisting of tert-butyl peroxybenzoate which can be found in Luperox® P; OO-tert-butyl-O-(2-ethylhexyl)-monoperoxycarbonate which can be found in Luperox® TBEC and OO-tert-amyl-O(2ethylhexyl)-monoperoxycarbonate which can be found in Luperox® TAEC.

Even more preferably, the organic peroxide according to the invention is tert-butyl peroxybenzoate, of formula (III).

As intended herein a “ketone peroxide” refers to an organic compound comprising at least one peroxide functional group (—OOH).

The ketone peroxide according to the invention is of the following formula (VIII):

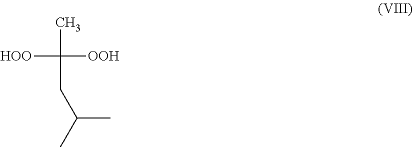

By way of example, the ketone peroxide according to the invention can be found in Luperox® K2.

Preferably, the organic peroxide of formula (I) as defined above is liquid at ambient temperature.

The curing agent according to the invention may further comprise at least one solvent. The solvent according to the invention can be of any type known to one of skill in the art suitable for solvating organic peroxides. Preferably, the solvent according to the invention is an organic solvent selected from the group consisting of a ketone solvent, an aryl solvent, an ether solvent, an alcohol solvent, a mineral oil and a hydrocarbon solvent. More preferably, the solvent is selected form the group consisting of dimethyl phthalate, dimethyl tetraphthalate, methyl isobutyl ketone, cyclohexanone, ethyl acetate, isododecane, or a combination thereof.

Preferably, the curing agent according to the invention comprises from 10 to 70% wt of organic peroxide of formula (I) and from 30 to 90% wt of methyl isobutyl ketone peroxide, preferably from 10 to 30% wt of organic peroxide of formula (I) and from 30 to 45% wt of methyl isobutyl ketone peroxide and more preferably from 15 to 25% wt of organic peroxide of formula (I) and from 35 to 40% wt of ketone peroxide according to the invention, relative to the total weight of the curing agent, optionally the remainder being the solvent according to the invention.

Even more preferably, the curing agent comprises about 20% wt of organic peroxide of formula (I) and about 38% wt of methyl isobutyl ketone peroxide, relative to the total weight of the curing agent, optionally the remainder being the solvent according to the invention.

Most preferably, the curing agent according to the invention comprise from 15 to 25% of Luperox® P and from 75 to 85% of Luperox® K2. Even most preferably, the curing agent according to the invention comprise about 20% of Luperox® P and about 80% of Luperox® K2.

The curing agent according to the invention may further comprises at least one plasticizer.

The plasticizer according to the invention can be of any type known to one of skill in the art. Preferably, the plasticizer according to the invention is selected from the group consisting of dimethyl phthalate, diethyl phthalate, dibutyl phthalate, di-(2-ethylhexyl) phthalate, polypropylene glycol and polyethylene glycol.

The curing agent according to the invention is preferably stable at room temperature. As intended herein “stable” means that the curing agent does not substantially degrade or loose its curing properties and “room temperature” preferably relates to a range of temperatures of from 15° C. to 30° C. As such, in a particular embodiment of the invention, the curing agent according to the invention can be stored, in particular stably stored, at a temperature of from 0 to 35° C., more preferably from 10 to 30° C., even more preferably from 15 to 27° C., in particular for at least 6 months, 12 months or 18 months. In an embodiment of the invention the curing agent according of the invention is not stored for more than 24 months, 36 months or 48 months.

Composition

As intended herein, the expression “polymer resin” refers to a polymer in association with a reactive monomer.

As intended herein, the expression “polymer ester resin” refers to a polymer comprising repetitive ester units in association with a reactive monomer. Preferably, the polymer resin, in particular the polymer ester resin, according to the invention is selected from the group consisting of an unsaturated polyester resin, acrylic resin, methacrylic resin and a vinyl ester resin. More preferably, the polymer ester resin is chosen in the group consisting of unsaturated polyester resin and vinyl ester resin, and even more preferably, the polymer resin is an unsaturated polyester resin.

Methods for the synthesis of a polymer resin are well known to one of skill in the art.

Preferably, the polymer is dissolved in a reactive monomer composition, i.e. a composition which comprises the reactive monomer. Preferably, said reactive monomer according to the invention may react with the polymer according to the invention by a copolymerisation reaction.

Preferably, the reactive monomer is selected from the group consisting of a vinylic compound, an acrylic compound and an allylic compound.

By way of example of a vinylic compound which can be used according to the invention, it is possible to cite a styrene compound, such as styrene, methylstyrene, p-chlorostyrene, t-butylstyrene, divinylbenzene or bromostyrene, vinylnaphthalene, divinylnaphtalene, vinylacetate, vinylpropionate, vinylpivalate, vinylether and divinylether.

By way of example of an acrylic compound which can be used according to the invention, it is possible to cite methylacrylate, ethylacrylate, propylacrylate, isopropylacrylate, butylacrylate, isobutylacrylate, phenylacrylate, and benzylacrylate.

By way of example of an allyl compound which can be used according to the invention, it is possible to cite allylphthalate, diallylphthalate, diallylisophthalate, triallylcyanurate and diallylterephthalate.

Preferably, the polymer of the unsaturated polyester resin according to the invention is obtainable by condensation of one or more acid monomers and/or one or more acid anhydride monomers with one or more polyol monomers provided that at least one of the component comprises an ethylenic unsaturation. More preferably, the unsaturated polyester resin according to the invention is obtained by condensation of one more polycarboxylic acid monomers and/or one or more polycarboxylic acid anhydride monomers and one or more glycol monomers, provided that at least one of the component comprises an ethylenic unsaturation.

Preferably, the polymer of the vinyl ester resin according to the invention is obtainable by condensation of one or more polyepoxide resin with one or more monocarboxylic acid monomer having an ethylenic unsaturation.

The acid monomer according to the invention can be of any type known to one of skill in the art. However, the acid monomer according to the invention is preferably selected from the group consisting of phthalic acid, maleic acid, oxalic acid, malonic acid, isophthalic acid, tetrahydrophthalic acid, hexahydrophthalic acid, succinic acid, sebacic acid, azelaic acid, adipic acid and fumaric acid.

The monocarboxylic acid monomer according to the invention can be of any type known to one of skill in the art. Preferably, the monocarboxylic acid monomer according to the invention is selected from the group consisting of acrylic acid such as methacrylic acid, ethylacrylic acid, propylacrylic acid, isopropylacrylic acid, butylacrylic acid, isobutylacrylic acid, phenylacrylic acid, benzylacrylic acid, halogenated acrylic acid, and cinnamic acid.

The acid anhydride monomer according to the invention can be of any type known to one of skill in the art. Preferably, the acid anhydride monomer according to the invention is selected from the group consisting of phthalic anhydride, maleic anhydride, oxalic anhydride, malonic anhydride, isophthalic anhydride, tetrahydrophthalic anhydride, hexahydrophthalic anhydride, succinic anhydride, sebacic anhydride, azelaic anhydride, adipic anhydride and fumaric anhydride.

The polyol according to the invention can be of any type known to one of skill in the art. Preferably, the polyol according to the invention is a glycol selected from the group consisting of an aliphatic diol and an aromatic diol. More preferably, the polyol according to the invention is selected from the group consisting of ethylene glycol, propylene glycol, diethylene glycol, dipropylene glycol, triethylene glycol, tripropylene glycol, pentylene glycol, hexylene glycol and neopentylene glycol.

The polyepoxide resin according to the invention can be of any type known to one of skill in the art. The polyepoxide resin according to the invention is preferably selected from the group consisting of glycidyl polyethers of polyhydric alcohols and glycidyl polyethers of polyhydric phenols.

Preferably, the polymer resin, in particular the polymer ester resin, preferably selected in the group consisting of unsaturated polyester resin acrylic resin, methacrylic resin and vinyl ester resin, according to the invention is a thermosetting resin.

As should be clear to one of skill in the art, the polymer resin, in particular the polymer ester resin, preferably chosen in the group consisting of unsaturated polyester resin acrylic resin, methacrylic resin and vinyl ester resin, according to the invention is preferably curable by addition of a curing agent according to the invention under a temperature allowing the curing reaction.

Preferably, the composition according to the invention comprises from 0.1 to 50% wt, more preferably from 0.5 to 40% wt of the polymer resin, in particular the polymer ester resin, preferably selected in the group consisting of unsaturated polyester resin acrylic resin, methacrylic resin and vinyl ester resin, according to the invention relative to the total weight of the composition.

The mineral filler according to the invention can be of any type well known to one of skill in the art. Preferably, the mineral filler according to the invention is made from crushed stone, in particular crushed non-synthetic stone. More preferably, the mineral filler according to the invention is selected from the group consisting of quartz aggregates, quartz particles, quartz powder, marble aggregates, marble particles, marble powder, granite aggregates, granite particles and granite powder.

Preferably, the content of the mineral filler is in the range of from 30 to 99.3% wt, notably, from 50 to 90% wt relative to the total weight of the composition. More preferably, the content of the mineral filler according to the invention is about 85% wt relative to the total weight of the composition.

Preferably, the average particle size of the mineral filler according to the invention is more than 0.001, 0.002, 0.003, 0.004, 0.005, 0.006, 0.007, 0.008, 0.009 or 0.010 mm. Preferably also, the average particle size of the mineral filler according to the invention is less than 10, 9, 8, 7, 6, 5, 4, 3, 2 or 1 mm. More preferably, the particle size of the mineral filler according to the invention is from 0.005 to 5 mm.

Even more preferably, the particle size distribution of the mineral filler is as defined below:
about 55 to 65% wt of the mineral filler according to the invention has a particle size in the range of 0.075 to 5 mm, relative to the total weight of mineral filler in the composition;
about 20 to 30% wt of the mineral filler according to the invention has a particle size in the range of 0.005 to 0.045 mm, relative to the total weight of mineral filler in the composition.

The coupling agent according to the invention can be of any type known to one of skill in the art. However, it is preferred that the coupling agent according to the invention is a silane coupling agent, preferably of the following formula (IX):

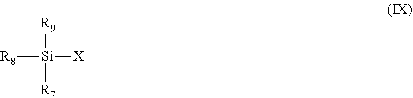

wherein,
X represents a vinyl group, an epoxy group, an amino group, a methacryloxy group or an acryloxy group; and
R₉, R₁₀ and R₁₁ each independently represents an alkyloxy group having from 1 to 6 carbon atoms or an alkyl group having from 1 to 6 carbon atoms.

Preferably, the silane coupling agent according to the invention is selected from the group consisting of a vinyl silane such as vinyltrimethoxysilane and vinyltriethoxysilane, a methacryloxy silane such as 3-methacryloxypropyl methyldimethoxysilane, 3-methacryloxypropyltrimethoxysilane, 3-methacryloxypropyl methyldiethoxysilane and 3-methacryloxypropyl triethoxysilane, an acryloxy silane such as 3-acryloxypropyl trimethoxysilane.

Preferably, the composition according to the invention comprises from 0.1 to 20% wt of the coupling agent and more preferably from 1 to 10% wt of the coupling agent relative to the total weight of the composition.

More preferably, the composition according to the invention comprises from 0.1 to 20% wt of the silane coupling agent, and even more preferably from 1 to 10% wt of the silane coupling agent relative to the total weight of the composition.

The colorant according to the invention can be of any type known to one of skill in the art. Preferably, the colorant is selected from the group consisting of azo compounds, anthraquinone compounds, indigo derivatives, triarylmethane compounds, chlorine compounds and polymethine compounds.

The pigment according to the invention can be of any type known to one of skill in the art. Preferably, the pigment according to the invention is selected from the group consisting of titanium dioxide, carbon black, cobalt oxide, nickel titanate, molybdenum disulfide, aluminium flakes, iron oxide, zinc oxide, organic pigments such as phthalocyanine and anthraquinone derivatives, and zinc phosphate.

The accelerator according to the invention can be of any type known to one of skill in the art. Preferably, the accelerator according to the invention is selected from the group consisting of metal salts such as cobalt salt, zinc salt, amine based compounds, iron based compounds and manganese based compounds. Preferably, the accelerator according to the invention is a cobalt-free and zinc-free accelerator.

The inhibitor according to the invention can be of any type known to one of skill in the art. Preferably, the inhibitor according to the invention is selected from the group consisting of tertiary butyl catechol, hydroquinone and toluhydroquinone.

The diluent according to the invention can be of any type known to one of skill in the art. Preferably, the diluent according to the invention is selected from an organic diluent.

The dispersing agent according to the invention can be of any type known to one of skill in the art. Preferably, the dispersing agent according to the invention is a silane compound. The UV stabilizer according to the invention can be of any type known to one of skill in the art. Preferably the UV stabilizer according to the invention is selected from the group consisting of resorcinol derivatives, benzotriazoles, phenyl triazine and salicylates.

Preferably, the composition according to the invention is a thermosetting composition, which can in particular be formed in a desired shape and cured to yield a synthetic stone shaped article.

Preferably, the composition according to the invention has a peak temperature below 150, 149, 148, 147, 147, 149, 145, 144, 143, 142, or 141° C. with a curing temperature of 82° C.

Alternatively, the composition according to the invention has a peak temperature below 175, 174, 173, 172, 171, 169, 168, 167, 166 or 165° C. with a curing temperature of 90° C. Preferably, the composition according to the invention comprises from 0.1 to 10% wt of the curing agent as defined above, relative to the total weight of the composition.

Synthetic Stone

Preferably, the preparation of the synthetic stone according to the invention comprises the steps of:
optionally, preparing a composition according to the invention, and
optionally, forming the composition into a desired shape, and subjecting the composition to a temperature allowing curing.

The composition according to the invention can be formed into various shapes, in particular by vibration moulding and compression under vacuum. The composition according to the invention is then submitted to a temperature allowing the curing reaching a synthetic stone in the desired form. The synthetic stone may then be cooled and eventually polished.

Preferably the temperature allowing curing, or curing temperature according to the invention is from 70 to 100° C., more preferably from 75 to 95° C., even more preferably from 80 to 92° C. More preferably, the reaction temperature is 90° C.

Preferably, when the composition according to the invention is dissolved in styrene, then a low content of residual styrene is obtained. Preferably, the residual styrene is comprised between 1 and 25 ppm, more preferably between 3 and 7 ppm.

Preferably, the synthetic stone according to the invention is selected from the group consisting of a synthetic metamorphic stone, a synthetic crystalline stone and a synthetic sedimentary stone, in particular a synthetic quartz, a synthetic granite and a synthetic marble.

Examples of shaped articles in synthetic stone produced according to the invention include external and internal walls, table tops, architectural facing, light fixture, bathroom articles, sinks, floor, tiles and countertops.

### DESCRIPTION OF THE FIGURES

FIG. 1 is a graph representing the temperature (vertical axis) of the composition containing Luperox® K2 (curve B) and of the composition containing Luperox® 26 (curve C) as function of time (horizontal axis).

FIG. 2 is a graph representing the temperature (vertical axis) of compositions containing the curing agent according to the invention (curve A), Luperox® K2 (curve B) and Luperox® 26 (curve C) as function of time (horizontal axis).

### EXAMPLES

1. Materials and Methods

1.1. Compositions

The following compositions were prepared by mixing all the components together (the data presented in table 1 are expressed by weight of components relative to the total weight of composition):

TABLE 1
Compositions E1, C2 and C3

| | Composition E1 | Composition C2 | Composition C3 |
|---|---|---|---|
| | (according to the | (comparative | (Comparative |
| Components | invention) | example) | example) |
| Unsaturated | 10% | 10% | 10% |
| polyester resin | | | |
| Mineral filler | 85% | 85% | 85% |
| Silane | 2% | 2% | 2% |
| Curing agent | 1% | 0% | 0% |
| (invention) | | | |
| Luperox ® 26 | 0% | 1% | 0% |
| Luperox ® K2 | 0% | 0% | 1% |

Luperox ®26 (Arkema) is a curing agent comprising tert-butylperoxy 2-ethylhexanoate.
Luperox ® K2 (Arkema) is a curing agent comprising methyl isobutyl ketone peroxide.

The curing agent according to the invention comprises 20% wt of Luperox® P (tert-butyl peroxybenzoate) and 80% wt of Luperox® K2 (methyl isobutyl ketone peroxide) with respect to the total weight of the curing agent.

The unsaturated polyester resin results from the polycondensation of anhydride maleic with isophthalic acid and a diol. The unsaturated polyester resin obtained is then dissolved in styrene.

The mineral filler comprises quartz aggregates, quartz particles and quartz powder with a particle size distribution as defined above:
55 to 65% wt of the mineral filler have a size particle from 0.075 to 5 mm; and
20 to 30% wt of the mineral filler have a size particle from 0.005 to 0.045 mm.

The silane compound is KH570 also known as 3-Methacryloxypropyltrimethoxysilane.

1.2. Evaluation of the Curing Properties

All the raw materials are well blended in a mixer for half an hour. The weight ratio of all raw materials are listed in the above Table 1. The total weight of the composition is 1 kg. Then all the raw materials are placed in a mould. The mould is then placed in an oven at desired temperature. Meanwhile one thermal couple is placed in the middle of the raw materials. The temperature is recorded by a computer (Gelprof 518, Wuhan Jiuwei Composites Company).

The curing properties of the compositions were analysed at 82° C. and at 90° C. by a temperature probe as function of time.

After curing, the mould is placed in room temperature to cool down.

1.3. Measure of the Residue of Styrene Monomer

The residues of styrene monomer were measured by Gas Chromatography with Headspace 24 hours after the curing process.

2. Results

2.1. Curing Properties

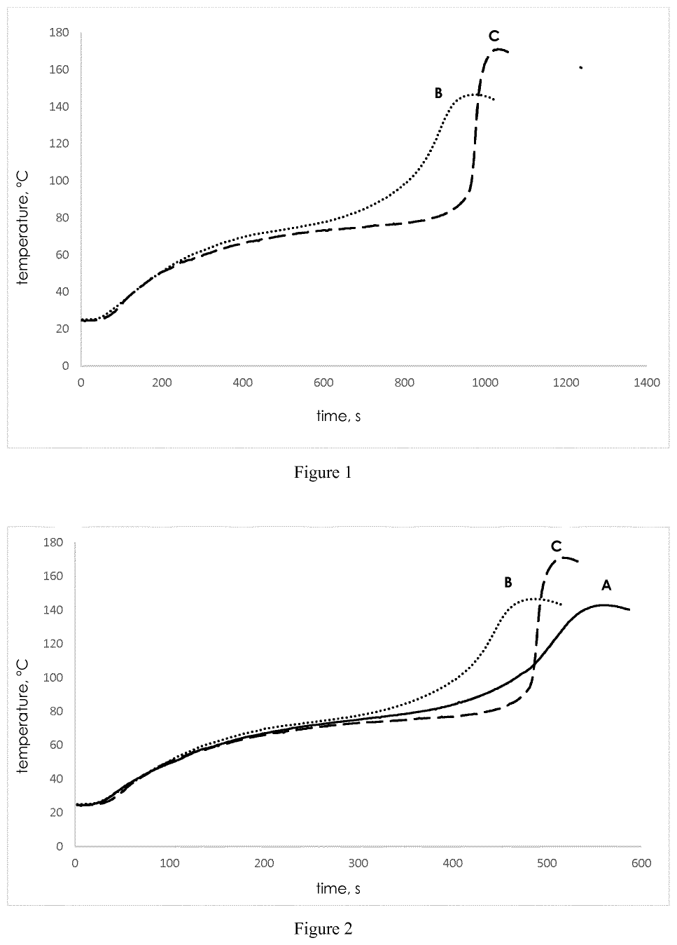

The results are presented in FIGS. 1 and 2, and the following Tables 2 and 3.

TABLE 2
Curing properties of the compositions E1, C2 and C3 at 82° C.

| Reaction temperature: | Peak | Peak | Styrene |
|---|---|---|---|
| 82° C. | time (s) | temperature (° C.) | residues (ppm) |
| E1 | 1,109 | 142.8 | 20,642 |
| C2 | 1,031 | 171.1 | 6,266 |
| C3 | 971 | 146.6 | 22,249 |

TABLE 3
Curing properties of Compositions E1 and C2 at 90° C.

| Reaction temperature: | Peak | Peak | Styrene |
|---|---|---|---|
| 90° C. | time (s) | temperature (° C.) | residues (ppm) |
| E1 | 837 | 166.9 | 5,939 |
| C2 | 573 | 173 | 5,800 |

In FIG. 1 and FIG. 2, the peak in the curve coincides with the formation of an insoluble material.

The results show that the reaction initiated by the curing agent according to the invention occurs at lower temperature. In addition, the slowest curing rate peak time is obtained for the composition E1 containing the curing agent according to the invention.

This means that the curing rate with the composition according to the invention is slower and thus allows the formation of synthetic stone by minimizing cracking or degradation.

Besides, when the temperature is 90° C., a low residual styrene content is obtained with the composition E1. This means that the reaction between the unsaturated polyester resin and the styrene in presence of the curing agent according to the invention reaches a high final conversion. Thus the release of residual styrene in the environment is limited leading to less volatile organic compound and less odours.

At 90° C., the peak temperature obtained for the composition C2 is higher and the peak time is obtained rapidly, this means that the curing rate is faster, the temperature may thus exceed the degradation temperature and this will cause degradation of the synthetic stone.

1. A curing agent comprising a methyl isobutyl ketone peroxide and at least one organic peroxide of the following formula (I):
R₁—O—O—R₂ (I)
wherein
R₁ represents an alkyl group having from 1 to 30 carbon atoms, an alkylen group having from 2 to 30 carbon atoms, an aryl group having from 3 to 30 carbon atoms or a cycloalkyl group having from 3 to 30 carbon atoms, wherein the alkyl, alkylen, aryl or cycloalkyl group is optionally substituted by an alkyl group having from 1 to 30 carbon atoms, an alkylen group having from 2 to 30 carbon atoms, an aryl group having from 3 to 30 carbon atoms or a cycloalkyl group having from 3 to 30 carbon atoms; and
R₂ represents a —C(═O)R₃, group, a —C(═O)OR₃ group, a —R₃OOR₄ group, an alkyl group having from 1 to 30 carbon atoms, an alkylen group having from 2 to 30 carbon atoms, an aryl group having from 3 to 30 carbon atoms or a cycloalkyl group having from 3 to 30 carbon atoms, wherein
the alkyl, alkylen, aryl or cycloalkyl group is optionally substituted by an alkyl group having from 1 to 30 carbon atoms, an alkylen group having from 2 to 30 carbon atoms, an aryl group having from 3 to 30 carbon atoms and a cycloalkyl group having from 3 to 30 carbon atoms, and
R₃ and R₄ each independently represents an alkyl group having from 1 to 30 carbon atoms, an alkylen group having from 2 to 30 carbon atoms, an aryl group having from 3 to 30 carbon atoms and a cycloalkyl group having from 3 to 30 carbon atoms, wherein the alkyl, alkylen, aryl or cycloalkyl group is optionally substituted by an alkyl group having from 1 to 30 carbon atoms, an alkylen group having from 2 to 30 carbon atoms, an aryl group having from 3 to 30 carbon atoms and a cycloalkyl group having from 3 to 30 carbon atoms.

2. The curing agent according to claim 1, wherein the organic peroxide of formula (I) has a one hour half life temperature ranging from 100° C. and 140° C.

3. The curing agent according to claim 1, wherein the organic peroxide of formula (I) is represented by the following formula (II):
R₅—O—O—R₆ (II)
wherein:
R₅ represents an alkyl group having from 1 to 6 carbon atoms, and
R₆ represents a —C(═O)R₇, a —C(═O)OR₇ group or a —R₇OOR₈ group, wherein R₇ and R₈ each independently represents an alkyl group having from 1 to 10 carbon atoms, a cycloalkyl group having from 3 to 6 carbon atoms or an aryl group having from 3 to 6 carbon atoms.

4. The curing agent according claim 1, wherein the organic peroxide of formula (I) is selected from the group consisting of tert-butyl peroxybenzoate, OO-tert-butyl-O-(2-ethylhexyl)-monoperoxycarbonate and OO-tert-amyl-O(2ethylhexyl)-monoperoxycarbonate.

5. The curing agent according to claim 1, comprising from 10 to 70% wt of the organic peroxide of formula (I) and from 30 to 90% wt of a methyl isobutyl ketone peroxide, relative to the total weight of the curing agent.

6. The curing agent according to claim 5, comprising about 20% wt of the organic peroxide of formula (I) and about 38% wt of methyl isobutyl ketone peroxide, relative to the total weight of the curing agent.

7. The curing agent according to claim 1, wherein the organic peroxide of formula (I) is liquid at ambient temperature.

8. A composition comprising:
at least one polymer resin,
at least one mineral filler, and
at least one curing agent as defined in claim 1.

9. The composition according to claim 8, comprising from 0.1 to 10% wt of the curing agent of claim 1, relative to the total weight of the composition.

10. The composition according to claim 8, comprising from 0.1 to 50% wt, of the polymer resin relative to the total weight of the composition.

11. The composition according to claim 8, comprising from 30 to 99.3% wt of the mineral filler relative to the total weight of the composition.

12. The composition according to claim 8, wherein the mineral filler is selected from the group consisting of quartz aggregates, quartz particles, quartz powder, marble aggregates, marble particles, marble powder, granite aggregates, granite particles and granite powder.

13. The composition according to claim 8, further comprising at least one additional agent selected from the group consisting of a coupling agent, a colorant, a pigment, an accelerator, an inhibitor, a diluent, a dispersing agent and an UV stabilizer.

14. The composition according to claim 13, comprising from 0.1 to 20% wt of the coupling agent relative to the total weight of the composition.

15. The composition according to claim 13, wherein the coupling agent is a silane.

16. (canceled)

17. (canceled)

18. A method for the preparation of a synthetic stone comprising the steps of:
optionally, preparing a composition as defined in claim 8, and
optionally, forming the composition into a desired shape, and
subjecting the composition to a temperature allowing curing.

19. A synthetic stone obtainable by the method as defined in claim 18.

20. The synthetic stone according to claim 19, wherein the stone is selected from the group consisting of a synthetic metamorphic stone, a synthetic crystalline stone and a synthetic sedimentary stone, in particular a synthetic quartz, a synthetic granite and a synthetic marble.
